(19) United States
(12) Patent Application Publication
(10) Pub. No.: US 2025/0128979 A1
(43) Pub. Date: Apr. 24, 2025

(54) INORGANIC COMPOSITION ARTICLE

(71) Applicant: OHARA INC., KANAGAWA (JP)

(72) Inventors: SAYA KIKKAWA, KANAGAWA (JP); TOSHITAKA YAGI, KANAGAWA (JP); KOHEI OGASAWARA, KANAGAWA (JP)

(21) Appl. No.: 18/834,606

(22) PCT Filed: Jan. 31, 2023
(86) PCT No.: PCT/JP2023/002982

§ 371 Date: Jul. 30, 2024

(30) Foreign Application Priority Data
Jan. 31, 2022 (JP) 2022-012979

(51) Int. Cl. C03C 3/097; C03C 3/087; C03C 3/091

(52) U.S. Cl. CPC C03C 3/097; C03C 3/087; C03C 3/091

(57) ABSTRACT

This inorganic composition article is characterized by: being obtained by tempering a crystallized glass which contains, as the main crystal phase thereof, at least one selected from α-cristobalite and an α-cristobalite solid solution, and in which, when expressed as mass % of respective oxides, the contained amount of component SiO₂ is not less than 45.0% but less than 68.0%, the contained amount of component Al₂O₃ is 3.0-15.0%, the contained amount of the component Li₂O is 3.0-10.0%, the contained amount of component B₂O₃ is more than 0% but not more than 10.0%, the contained amount of component P₂O₅ is more than 0% but not more than 10.0%, the contained amount of the component ZrO₂ is more than 0% but not more than 10.0%; and the mass ratio of SiO₂/(B₂O₃+Li₂O) is 3.0-10.0; having a compressive stress layer on the surface thereof; and having a softening point (SP) of lower than 795° C.

### FIELD OF THE DISCLOSURE

The present disclosure relates to an inorganic composition article.

### BACKGROUND OF THE DISCLOSURE

Various types of glass are expected to be used as cover glass or housings for protecting displays of portable electronic devices such as smartphones and tablet PCs, as protectors for protecting lenses of in-vehicle optical devices, as interior bezels or console panels, touch panel materials, smart keys, and the like.

The glass is required to have not only high mechanical strength but also excellent thermal processability. Specifically, there is a demand for an inorganic material that can be easily processed by forming a flat glass into a curved shape through thermal processing during manufacturing.

Patent Document 1 discloses a crystallized glass having high bending strength and a low expansion coefficient. However, the crystallized glass described in Patent Document 1 has a high softening point (SP) so that it is difficult to produce a material having a complex and highly curved surface shape.

### PRIOR ART DOCUMENT

### Patent Document

Patent document 1: JP S61-083649 A

### SUMMARY OF THE DISCLOSURE

An object of the present disclosure is to provide an inorganic composition article having a softening point (SP) of less than 795° C.

The present disclosure provides the following configurations.

### Configuration 1

An inorganic composition article including at least one type selected from α-cristobalite and an α-cristobalite solid solution as a main crystalline phase,
in which, the inorganic composition article is obtained by reinforcing a crystallized glass where, by mass % in terms of oxide,
a content of a SiO₂ component is 45.0% to less than 68.0%,
a content of an Al₂O₃ component is 3.0% to 15.0%,
a content of a Li₂O component is 3.0% to 10.0%,
a content of a B₂O₃ component is more than 0% to 10.0%,
a content of a P₂O₅ component is more than 0% to 10.0%,
a content of a ZrO₂ component is more than 0% to 10.0%, and
a mass ratio represented by SiO₂/(B₂O₃+Li₂O) is 3.0 to 10.0, and
the inorganic composition article has a surface formed thereon with a compressive stress layer and a softening point (SP) of less than 795° C.

### Configuration 2

The inorganic composition article according to configuration 1, in which, in the crystallized glass, by mass % in terms of oxide,
a total content of the Al₂O₃ component and the ZrO₂ component is 10.0% or more.

### Configuration 3

The inorganic composition article according to configuration 1 or 2, in which, in the crystallized glass, by mass % in terms of oxide,
a content of a K₂O component is 0% to 5.0%,
a content of a Na₂O component is 0% to 4.0%,
a content of a MgO component is 0% to 4.0%,
a content of a CaO component is 0% to 4.0%,
a content of a SrO component is 0% to 4.0%,
a content of a BaO component is 0% to 5.0%,
a content of a ZnO component is 0% to 10.0%, and
a content of a Sb₂O₃ component is 0% to 3.0%.

### Configuration 4

The inorganic composition article according to any one of configurations 1 to 3, in which, in the crystallized glass, by mass % in terms of oxide,
a content of a Nb₂O₅ component is 0% to 5.0%,
a content of a Ta₂O₅ component is 0% to 6.0%, and
a content of a TiO₂ component is 0% or more and less than 1.0%.

### Configuration 5

The inorganic composition article according to any one of configurations 1 to 4, in which a glass transition temperature (Tg) of the crystallized glass after crystallization is 610° C. or lower.

According to the present disclosure, when the softening point is less than 795° C., the forming temperature is lowered, and thus, it becomes possible to manufacture glass at a relatively low temperature. Therefore, it is possible to manufacture an inorganic composition article easily processed not only by press-molding, but also by 3D processing, bending processing, and curved surface processing.

The “inorganic composition article” in the present disclosure (hereinafter, also simply referred to as the “article”) is formed of an inorganic composition material such as glass, crystallized glass, ceramics, or a composite material thereof. The article according to the present disclosure corresponds to, for example, an article formed into a desired shape, for example, by processing these inorganic materials or synthesizing them through a chemical reaction. In addition, the article according to the present disclosure also corresponds to a pressurized powder body obtained by crushing an inorganic material and then applying a pressure thereto, and a sintered body obtained by sintering the pressurized powder body, and the like. The shape of the article obtained here is not limited in terms of smoothness, curvature, size, and the like. For example, the article may be a plate-shaped substrate, a molded body having a curvature, or a three-dimensional structure having a complex shape.

The crystallized inorganic composition article according to the present disclosure has the strength of glass, but has a low softening point (SP) temperature, so that it can be press-molded at a relatively low temperature during glass production. In addition, after molding the inorganic composition article, more complicated and difficult processing involving thermal processing can also be carried out easily.

Therefore, taking advantage of the fact that the article is a glass-based material having strength and processability, the article can be employed for a protective member in equipment, etc. The article may be employed for a cover glass or a housing of a smartphone, a member of a portable electronic device such as a tablet PC and a wearable terminal, and a protective protector, a member of a substrate for a head-up display, or the like used in a transport vehicle such as a car and an airplane. Further, the article can also be employed for other electronic devices and machinery, a building member, a solar panel member, a projector member, and a cover glass (windshield) for eyeglasses and watches.

### DETAILED DESCRIPTION OF THE EXEMPLARY EMBODIMENTS

The embodiments and examples of the inorganic composition article according to the present disclosure will be described in detail below. However, the present disclosure is not limited to the following embodiments and examples, and may be implemented by making modifications as appropriate within the scope of the purpose of the present disclosure.

The inorganic composition article according to the present disclosure is a crystallized inorganic composition article having a surface formed thereon with a compressive stress layer, and has a softening point (SP) of less than 795° C.

The crystallized glass according to the present disclosure contains at least one type selected from α-cristobalite and an α-cristobalite solid solution, as a main crystalline phase. In the crystallized glass in which the crystalline phases are precipitated, it is possible to precipitate crystals with small grain sizes, and therefore, the crystallized glass has good transmittance and high mechanical strength.

The term “main crystalline phase” as used herein corresponds to the crystalline phase that is most abundant in crystallized glass as determined from the peaks of the X-ray diffraction pattern.

A content of each component is expressed herein as “by mass % in terms of an oxide” unless otherwise specified. Here, “in terms of an oxide” means, if it is assumed that all the constituent components included in the crystallized glass are dissolved and converted into oxides, when a total amount of the oxides is 100 mass %, an amount of oxides in each of the components contained in the crystallized glass is expressed by mass %. As used herein, “A % to B %” represents A % or more and B % or less.

The inorganic composition article according to the present disclosure is an inorganic composition article including at least one type selected from α-cristobalite and an α-cristobalite solid solution as a main crystalline phase,
in which, the inorganic composition article is obtained by reinforcing a crystallized glass where, by mass % in terms of oxide,
a content of a SiO₂ component is 45.0% to less than 68.0%,
a content of an Al₂O₃ component is 3.0% to 15.0%,
a content of a Li₂O component is 3.0% to 10.0%,
a content of a B₂O₃ component is more than 0% to 10.0%,
a content of a P₂O₅ component is more than 0% to 10.0%,
a content of a ZrO₂ component is more than 0% to 10.0%, and
a mass ratio represented by SiO₂/(B₂O₃+Li₂O) is 3.0 to 10.0, and
the inorganic composition article having a surface formed thereon with a compressive stress layer and a softening point (SP) of less than 795° C.

The inorganic composition article has the above-described main crystalline phase and composition, and thus, the crystallized glass has a low softening point temperature, and the meltability of the raw materials is increased, making it easier to manufacture, and it becomes easier to perform processing such as 3D processing on the obtained crystallized glass.

The composition range of each component included in the crystallized glass according to the present disclosure will be specifically described below.

The SiO₂ component is an essential component necessary for forming at least one type selected from α-cristobalite and an α-cristobalite solid solution. When the content of the SiO₂ component is less than 68.0%, it is possible to suppress an excessive increase in viscosity and a deterioration in meltability, and when the content is 45.0% or more, it is possible to suppress a deterioration in resistance to devitrification.

An upper limit is preferably less than 68.0%, 67.0% or less, or less than 66.0%. Also, a lower limit is preferably 45.0% or more, 50.0% or more, 53.0% or more, or 55.0% or more.

The Li₂O component is a component that improves the meltability of raw glass. When the content of the Li₂O component is 3.0% or more, it is possible to obtain an effect of improving the meltability of raw glass, and when the content of the Li₂O component is 10.0% or less, it is possible to suppress the formation of lithium disilicate crystals. Also, the Li₂O component is a component that contributes to chemical strengthening.

A lower limit is preferably 3.0% or more, 3.5% or more, 4.0% or more, 4.5% or more, 5.0% or more, or 5.5% or more. Also, an upper limit is preferably 10.0% or less, 9.0% or less, or 8.5% or less.

The Al₂O₃ component is a component suitable for improving the mechanical strength of the crystallized glass. When the content of the Al₂O₃ component is 15.0% or less, it is possible to suppress a deterioration in meltability and a resistance to devitrification, and when the content is 3.0% or more, it is possible to suppress a deterioration in mechanical strength.

An upper limit is preferably 15.0% or less, less than 15.0%, 14.5% or less, 14.0% or less, 13.5% or less, or 13.0% or less. Also, a lower limit can be 3.0% or more, 3.5% or more, 4.0% or more, 4.5% or more, or 5.0% or more.

The B₂O₃ component is a component suitable for lowering the softening point temperature of the crystallized glass, and when the content is 10.0% or less, it is possible to suppress a deterioration in chemical durability.

An upper limit is preferably 10.0% or less, 8.0% or less, 7.0% or less, 5.0% or less, or 4.0% or less. Also, a lower limit is preferably more than 0%, 0.001% or more, 0.01% or more, 0.05% or more, 0.10% or more, or 0.30% or more.

The P₂O₅ component is an essential component that is added to act as a crystal nucleation agent for glass. When the content of the P₂O₅ component is 10.0% or less, it is possible to suppress a deterioration in resistance to devitrification of the glass and phase separation of the glass.

An upper limit is preferably 10.0% or less, 8.0% or less, 6.0% or less, 5.0% or less, or 4.0% or less. Also, a lower limit can be more than 0%, 0.5% or more, 1.0% or more, or 1.5% or more.

The ZrO₂ component is a component that can improve the mechanical strength, and when the content of the ZrO₂ component is 10.0% or less, it is possible to suppress a deterioration in meltability.

An upper limit is preferably 10.0% or less, 9.0% or less, 8.5% or less, or 8.0% or less. Also, a lower limit can be more than 0%, 1.0% or more, 1.5% or more, or 2.0% or more.

The mass ratio represented by SiO₂/(B₂O₃+Li₂O) is preferably 3.0 to 10.0. When the mass ratio is 3.0 to 10.0, it is possible to contribute to lowering of viscosity of the glass, making it easier to produce the glass, and to increase the amount of alkali ions that are ion-exchanged during chemical strengthening.

Therefore, a lower limit of the mass ratio represented by SiO₂/(B₂O₃+Li₂O) is preferably 3.0 or more, more preferably 3.5 or more, and still more preferably 4.64 or more. Moreover, an upper limit of the mass ratio represented by SiO₂/(B₂O₃+Li₂O) is preferably 10.0 or less, more preferably 9.5 or less, and still more preferably less than 8.6, 7.5 or less, or 7.3 or less.

When [SiO₂+Li₂O+Al₂O₃+B₂O₃], which is the sum of the contents of the SiO₂ component, the Li₂O component, the Al₂O₃ component, and the B₂O₃ component, is high, it is possible to obtain glass that can be easily chemically strengthened and has high strength. Therefore, a lower limit of [SiO₂+Li₂O+Al₂O₃+B₂O₃] is preferably 75.0% or more, 77.0% or more, or 79.0% or more.

When [Al₂O₃+ZrO₂], which is the sum of the contents of the Al₂O₃ component and the ZrO₂ component, is high, the compressive stress on the surface increases when the glass is strengthened. A lower limit of [Al₂O₃+ZrO₂] is preferably 10.0% or more, 11.0% or more, 12.0% or more, or 13.0% or more.

On the other hand, when the content is 22.0% or less, it is possible to suppress a deterioration in meltability. Therefore, an upper limit of [Al₂O₃+ZrO₂] is preferably 22.0% or less, 21.0% or less, 20.0% or less, or 19.0% or less.

The K₂O component is an optional component that is involved in chemical strengthening when the content exceeds 0%. A lower limit of the K₂O component can be 0% or more, more than 0%, 0.1% or more, 0.3% or more, or 0.5% or more.

Moreover, when the content of the K₂O component is 5.0% or less, it is possible to promote crystal precipitation. Therefore, an upper limit can be preferably 5.0% or less, 4.0% or less, 3.5% or less, or 3.0% or less.

The Na₂O component is an optional component that is involved in chemical strengthening when the content exceeds 0%. When the content of the Na₂O component is 4.0% or less, it is possible to easily obtain the desired crystalline phase. An upper limit can be preferably 4.0% or less, 3.5% or less, more preferably 3.0% or less, and still more preferably 2.5% or less.

A lower limit of the Na₂O component is not particularly limited, but can be, for example, 0% or more, more than 0%, 0.1% or more, 0.3% or more, or 0.5% or more.

Each of the MgO component, the CaO component, the SrO component, the BaO component, and the ZnO component is an optional component that improves a low-temperature meltability when the content exceeds 0%, and the content can be within a range that does not impair the effects of the present disclosure.

Therefore, an upper limit of the MgO component can be preferably 4.0% or less, 3.5% or less, 3.0% or less, or 2.5% or less. Also, a lower limit of the MgO component can be preferably 0% or more, more than 0%, 0.3% or more, or 0.4% or more.

An upper limit of the CaO component can be preferably 4.0% or less, 3.0% or less, 2.5% or less, or 2.0% or less. Also, a lower limit of the CaO component can be preferably 0% or more, more than 0%, 0.3% or more, or 0.4% or more.

An upper limit of the SrO component can be preferably 4.0% or less, 3.0% or less, 2.5% or less, or 2.0% or less. Also, a lower limit of the SrO component can be preferably 0% or more, more than 0%, 0.3% or more, or 0.4% or more.

An upper limit of the BaO component can be preferably 5.0% or less, 4.0% or less, 3.0% or less, 2.5% or less, or 2.0% or less. Also, a lower limit of the BaO component can be preferably 0% or more, more than 0%, 0.3% or more, or 0.4% or more.

An upper limit of the ZnO component can be preferably 10.0% or less, 9.0% or less, 8.5% or less, 8.0% or less, or 7.5% or less. Also, a lower limit of the ZnO component can be preferably more than 0%, 0.5% or more, or 1.0% or more.

The crystallized glass may or may not contain each of the Nb₂O₅ component, the Ta₂O₅ component, and the TiO₂ component, provided that the effects of the present disclosure are not impaired.

The Nb₂O₅ component is an optional component that improves the mechanical strength of the crystallized glass when the content exceeds 0%. An upper limit can be preferably 5.0% or less, 4.0% or less, 3.5% or less, or 3.0% or less. Also, a lower limit can be preferably 0% or more, more than 0%, 0.3% or more, or 0.4% or more.

The Ta₂O₅ component is an optional component that improves the mechanical strength of the crystallized glass when the content exceeds 0%. An upper limit can be preferably 6.0% or less, 5.5% or less, 5.0% or less, or 4.0% or less. Also, a lower limit can be preferably 0% or more, more than 0%, 0.3% or more, or 0.4% or more.

The TiO₂ component is an optional component that improves the chemical durability of the crystallized glass when the content exceeds 0%. An upper limit can be preferably less than 1.0%, 0.8% or less, 0.5% or less, or 0.1% or less. Also, a lower limit can be preferably 0% or more, more than 0%, 0.3% or more, or 0.4% or more.

Furthermore, the crystallized glass may or may not contain each of the La₂O₃ component, the Gd₂O₃ component, the Y₂O₃ component, the WO₃ component, the TeO₂ component, and the Bi₂O₃ component, provided that the effects of the present disclosure are not impaired. The content of each of the components can be 0% to 2.0%, 0% to less than 2.0%, or 0% to 1.0%.

Furthermore, the crystallized glass may or may not contain other components not mentioned above, provided that the properties of the crystallized glass according to the present disclosure are not impaired. For example, the crystallized glass may contain metal components such as Yb, Lu, V, Cr, Mn, Fe, Co, Ni, Cu, Ag, and Mo (including oxides of these metals).

The Sb₂O₃ component may be contained as a clarifying agent for the glass. On the other hand, when the content of the Sb₂O₃ component is 3.0% or less, it is possible to suppress a deterioration in transmittance in the short wavelength region of the visible light region. Therefore, an upper limit can be preferably 1.0% or less, 0.5% or less, or 0.3% or less.

Further, as a clarifying agent for glass, a SnO₂ component, a CeO₂ component, an As₂O₃ component, and one or more types selected from the group consisting of F, NOx, and SOx may or may not be contained in addition to the Sb₂O₃ component. Note that an upper limit of the content of the clarifying agent can be preferably 1.0% or less, 0.5% or less, or 0.3% or less. Also, a lower limit can be preferably 0% or more, more than 0%, 0.3% or more, or 0.4% or more.

On the other hand, there is a tendency to avoid the use of components including Pb, Th, Tl, Os, Be, Cl, and Se, which are considered in recent years to be harmful chemical substances, and therefore, it is preferable that such components are substantially not contained.

A compressive stress CS (MPa) of the compressive stress layer of the inorganic composition article according to the present disclosure is preferably 550 MPa or more, more preferably 600 MPa or more, and still more preferably 700 MPa or more. An upper limit is, for example, 1400 MPa or less, 1300 MPa or less, 1200 MPa or less, or 1100 MPa or less. When the compressive stress layer has such a compressive stress value, it is possible to suppress the progression of cracks and increase the mechanical strength.

A central tensile stress CT (MPa) is an index of the degree of strengthening of glass by chemical strengthening. For the impact resistance of the glass, the central tensile stress CT (MPa) of the inorganic composition article according to the present disclosure is preferably 40 MPa or more, more preferably 70 MPa or more, and still more preferably 100 MPa or more. The upper limit is, for example, 250 MPa or less, 230 MPa or less, or 210 MPa or less. When the inorganic composition article has such a central tensile stress, it is possible to obtain a desired strengthened crystallized glass by chemical strengthening.

A thickness DOLzero (μm) of the compressive stress layer is not limited because it also depends on the thickness of the crystallized glass. For example, when the thickness of the crystallized glass substrate is 0.7 mm, a lower limit of the thickness of the compressive stress layer can be 70 μm or more, or 100 μm or more. An upper limit is, for example, 180 μm or less, or 160 μm or less.

When crystallized glass is used as the substrate, a lower limit of the thickness of the substrate is preferably 0.05 mm or more, more preferably 0.1 mm or more, still more preferably 0.2 mm or more, yet still more preferably 0.3 mm or more, and even more preferably 0.4 mm or more, and an upper limit of the thickness of the crystallized glass is preferably 2.0 mm or less, more preferably 1.5 mm or less, still more preferably 1.1 mm or less, yet still more preferably 1.0 mm or less, even more preferably 0.9 mm or less, and further more preferably 0.8 mm or less.

The crystallized glass can be produced by the following method. That is, the raw materials are uniformly mixed so that the content of each component falls within a prescribed range, and then melt-molded to produce raw glass. Next, the raw glass is crystallized to produce crystallized glass.

The softening point (SP) of the inorganic composition article according to the present disclosure is preferably less than 795° C., and more preferably less than 790° C.

The Tg of the glass after crystallization of the inorganic composition article according to the present disclosure is preferably 610° C. or less, more preferably 600° C. or less, and still more preferably 590° C. or less.

The heat treatment for crystal precipitation may be performed at a one-stage temperature or a two-stage temperature.

The two-stage heat treatment includes a nucleation step of firstly treating the raw glass by heat at a first temperature and a crystal growth step of treating, after the nucleation step, the glass by heat at a second temperature higher than that in the nucleation step.

The first temperature of the two-stage heat treatment can be preferably 450° C. to 750° C., more preferably 500° C. to 720° C., and still more preferably 550° C. to 680° C. The retention time at the first temperature is preferably 30 minutes to 2000 minutes, and more preferably 180 minutes to 1440 minutes.

The second temperature of the two-stage heat treatment can be preferably 550° C. to 850° C., and more preferably 600° C. to 800° C. The retention time at the second temperature is preferably 30 minutes to 600 minutes, and more preferably 60 minutes to 400 minutes.

In the one-stage heat treatment, the nucleation step and the crystal growth step are continuously performed at the one-stage temperature. Typically, the temperature is raised to a predetermined heat treatment temperature, is maintained for a certain period of time after reaching the predetermined heat treatment temperature, and is then lowered.

In the case of one-stage heat treatment, the heat treatment temperature is preferably 600° C. to 800° C., and more preferably 630° C. to 770° C. Further, the retention time at the heat treatment temperature is preferably 30 minutes to 500 minutes, and more preferably 60 minutes to 400 minutes.

An example of a method for forming the compressive stress layer in the inorganic composition article includes a chemical strengthening method in which an alkaline component present in a surface layer of the crystallized glass is subjected to an exchange reaction with an alkaline component with a larger ionic radius to form a compressive stress layer on the surface layer. Other methods include a heat strengthening method in which crystallized glass is heated and then rapidly cooled, and an ion implantation method in which ions are implanted into the surface layer of crystallized glass.

The inorganic composition article according to the present disclosure can be produced, for example, by the following chemical strengthening method.

A crystallized glass is contacted with or immersed in a molten salt of a salt containing potassium and sodium, for example, a mixed salt or a complex salt of potassium nitrate (KNO₃) and sodium nitrate (NaNO₃). The treatment of contacting or immersing the crystallized glass with or in the molten salt may be performed in one stage or in two stages.

In the case of the two-stage treatment, firstly, the crystallized glass is contacted with or immersed in a sodium salt or a mixed salt of potassium and sodium heated at 350° C. to 550° C. for 1 minute to 1440 minutes, preferably 30 minutes to 500 minutes. Subsequently, secondly, the resultant crystallized glass is contacted with or immersed in a potassium salt or a mixed salt of potassium and sodium heated at 350° C. to 550° C. for 1 minute to 1440 minutes, preferably 60 minutes to 600 minutes.

In the case of the two-stage treatment, it is desirable to use a single bath of sodium nitrate (NaNO₃) or a molten salt of a salt containing potassium and sodium, such as a mixed salt or a complex salt of potassium nitrate (KNO₃) and sodium nitrate (NaNO₃) in the first stage treatment, and a single bath of potassium nitrate (KNO₃) or a salt containing potassium and sodium in the second stage treatment.

In the case of the one-stage chemical strengthening treatment, the crystallized glass is contacted with or immersed in a single bath of sodium nitrate (NaNO₃) heated at 350° C. to 550° C. or in a mixed salt containing potassium and sodium for 1 minute to 1440 minutes, preferably 30 minutes to 500 minutes.

When the chemical strengthening treatment as described above is carried out, a compressive stress layer can be formed on the surface of the glass to increase the compressive stress CS.

### EXAMPLES

### Examples 1 to 16, Comparative Example 1

### 1. Preparation of Inorganic Composition Article

Raw materials such as oxides, hydroxides, carbonates, nitrates, fluorides, chlorides, and metaphosphate compounds were selected respectively for the raw materials for each component of the crystallized glass, and the raw materials were weighed and mixed uniformly to have the compositions shown in Table 1.

Next, the mixed raw materials were fed into a platinum crucible and melted in an electric furnace at 1300° C. to 1600° C. for 2 hours to 24 hours. Subsequently, the molten glass was stirred and homogenized, cast into a mold after lowering the temperature to 1000° C. to 1450° C., and slowly cooled to produce raw glass.

The obtained raw glass was heated under crystallization conditions including a nucleation step at 600° C. for 5 hours and a crystal growth step at 640° C. to 700° C. for 5 hours in Examples 1 to 8, 10 to 16, and Comparative Example 1, and heated under continuous crystallization conditions including a nucleation step and a crystal growth step at 640° C. to 700° C. for 5 hours in Example 9 to produce the crystallized glass.

The crystalline phase of the crystallized glass was determined from the angles of the peaks appearing in an X-ray diffraction pattern obtained using an X-ray diffraction analyzer (D8Discover, manufactured by Bruker Corporation). When the X-ray diffraction patterns were examined, all of the samples had a main peak (the peak with the highest intensity and the largest peak area) at a position corresponding to the peak pattern of α-cristobalite and/or an α-cristobalite solid solution, indicating that α-cristobalite and/or an α-cristobalite solid solution had precipitated as the main crystalline phase.

The glass softening point (SP) of the inorganic composition articles after crystallization in Examples 1 to 16 and Comparative Example 1 was measured using a glass parallel plate viscometer PPVM-1100SS manufactured by Opto Enterprises, and the temperature corresponding to a viscosity of 10^{7.65} dPa·s was set as the softening point.

The glass transition point (Tg) of the glass of the inorganic composition article after crystallization in Examples 1 to 16 was measured in accordance with the Japan Optical Glass Manufacturers' Association Standard JOGIS08-2019 “Measuring Method for Thermal Expansion of Optical Glass”.

The crystallized glasses produced according to Table 1 were cut and ground, the opposite surfaces were subjected to parallel polishing to result in the thicknesses shown in Tables 2 and 3, and a crystallized glass substrate was obtained. The crystallized glass substrate was used as a base material to obtain an inorganic composition article. Thereafter, the substrate was strengthened in two stages at the temperatures and times shown in Tables 2 and 3. Specifically, in the case of Example 1, the substrate was immersed in a mixed bath of KNO₃ and NaNO₃ with a weight ratio of KNO₃:NaNO₃=20:1 at 450° C. for 120 minutes in the first stage, and in a single bath of KNO₃ at 400° C. for 300 minutes in the second stage.

TABLE 1

| | | | Example | | | | | | | | |
|---|---|---|---|---|---|---|---|---|---|---|---|
| | | | 1 | 2 | 3 | 4 | 5 | 6 | 7 | 8 | 9 |
| Composition | [symbol] | | 60.00 | 65.68 | 65.85 | 64.86 | 64.81 | 80.00 | 59.00 | 58.00 | 60.00 |
| (mass %) | [symbol] | | 12.10 | 9.44 | 6.24 | 12.74 | 12.72 | [symbol] | 10.10 | 10.10 | 12.10 |
| | [symbol] | | 3.00 | 7.00 | 4.00 | 3.00 | 2.00 | 3.00 | 3.00 | 4.00 | 3.00 |
| | [symbol] | | 3.80 | 2.04 | 2.25 | 2.04 | 2.14 | 3.80 | 3.80 | 3.80 | 3.60 |
| | [symbol] | | 6.97 | 7.14 | 8.14 | 7.24 | 7.13 | [symbol] | 6.97 | 6.47 | 6.97 |
| | [symbol] | | 1.00 | | | | 0.50 | 1.00 | 1.00 | 1.00 | 2.00 |
| | [symbol] | | 0.50 | 1.53 | 1.73 | | 0.73 | 0.50 | 1.00 | 0.50 | |
| | [symbol] | | 1.10 | 0.41 | 1.02 | 2.02 | 1.02 | | 1.60 | 1.10 | |
| | [symbol] | | | | | 0.41 | 0.41 | | | 0.50 | |
| | [symbol] | | 1.25 | | | | | 1.25 | 1.25 | 1.25 | [symbol] |
| | [symbol] | | 4.60 | 1.08 | 2.88 | 3.11 | 2.88 | 6.60 | 6.60 | 7.60 | 8.20 |
| | [symbol] | | 5.60 | 5.60 | 7.60 | [symbol] | 5.60 | 5.60 | 5.60 | 5.62 | 5.68 |
| | [symbol] | | | | | | | | | | |
| | [symbol] | | | | | | | | | | |
| | [symbol] | | 0.08 | 0.08 | 0.08 | 0.08 | 0.08 | 0.08 | 0.08 | 0.08 | |
| | Total | | 100.00 | 100.00 | 100.00 | 100.00 | 100.00 | 100.00 | 100.00 | 100.00 | 100.00 |
| [symbol] | | | 82.07 | 89.26 | 84.24 | 87.74 | 86.66 | 80.07 | 79.07 | 78.57 | 80.07 |
| [symbol] | | | 17.70 | 15.04 | [symbol] | 17.34 | 18.32 | 15.70 | 15.70 | 15.72 | 15.78 |
| [symbol] | | | 6.02 | 4.64 | 5.43 | 6.40 | 7.10 | 6.02 | 5.92 | 5.54 | 6.02 |
| Crystal- | Nucleation | Temper- | 600 | 600 | 600 | 600 | 600 | 600 | 600 | 600 | — |
| lization | | ature | | | | | | | | | |
| conditions | | [° C.] | | | | | | | | | |
| | | Retention | 5 | 5 | 5 | 5 | 5 | 5 | 5 | 5 | — |
| | | time [h] | | | | | | | | | |
| | Crystal | Temper- | 680 | 640 | 640 | 640 | 660 | 670 | 680 | 520 | 670 |
| | growth | ature | | | | | | | | | |
| | | [° C.] | | | | | | | | | |
| | | Retention | 5 | 5 | 5 | 5 | 5 | 5 | 5 | 5 | 5 |
| | | time [h] | | | | | | | | | |
| Glass transition point (Tg) [° C.] | | | 586 | [symbol] | 545 | 541 | 579 | | | | |
| Softening point (SP) [° C.] | | | 779 | [symbol] | 748 | 762 | 759 | 784 | 775 | 766 | 786 |
| | | | | Example | | | | | | | Comparative |
| | | | | 10 | 11 | 12 | 13 | 14 | 15 | 16 | Example 1 |
| | Composition | [symbol] | | 60.00 | 63.30 | 60.00 | 59.00 | 59.00 | 59.00 | 59.00 | [symbol] |
| | (mass %) | [symbol] | | [symbol] | 7.50 | 9.10 | 10.10 | 10.10 | 10.10 | 10.10 | 12.44 |
| | | [symbol] | | 3.00 | 3.50 | 3.00 | 3.00 | 3.00 | 3.00 | 3.00 | |
| | | [symbol] | | 3.80 | 2.00 | 3.60 | [symbol] | 3.80 | 3.80 | 3.60 | 2.04 |
| | | [symbol] | | 6.97 | 6.00 | 6.97 | 6.97 | 6.97 | 7.17 | [symbol] | 7.14 |
| | | [symbol] | | 1.00 | 3.00 | 3.00 | 1.00 | 1.00 | 0.80 | 1.00 | |
| | | [symbol] | | | | | 1.00 | 1.00 | 1.00 | 1.00 | 1.53 |
| | | [symbol] | | | 0.40 | 0.60 | 1.35 | 1.85 | 1.50 | 1.60 | 1.02 |
| | | [symbol] | | | | | 1.00 | | | | 0.41 |
| | | [symbol] | | 1.25 | 0.72 | 1.25 | | | 1.25 | | |
| | | [symbol] | | [symbol] | 5.50 | [symbol] | [symbol] | 7.60 | 6.60 | 6.60 | 4.08 |
| | | [symbol] | | [symbol] | [symbol] | 5.60 | [symbol] | [symbol] | 5.60 | 6.85 | 5.60 |
| | | [symbol] | | | 2.00 | | | | | | |
| | | [symbol] | | | | | | | | | |
| | | [symbol] | | | 0.08 | 0.08 | 0.08 | 0.08 | 0.08 | 0.08 | 0.08 |
| | | Total | | 100.00 | 100.00 | 100.00 | 100.00 | 100.00 | 100.00 | 100.00 | 100.00 |
| | [symbol] | | | 80.07 | 80.30 | 79.07 | 79.07 | 79.07 | 79.27 | 79.07 | 85.24 |
| | [symbol] | | | 15.78 | 13.50 | 14.70 | 15.70 | 15.70 | 15.70 | 16.95 | 18.04 |
| | [symbol] | | | 6.02 | 6.66 | 6.02 | 5.92 | [symbol] | [symbol] | 5.92 | 0.20 |
| | Crystal- | Nucleation | Temper- | 600 | 600 | 620 | 600 | 600 | 600 | 600 | 600 |
| | lization | | ature | | | | | | | | |
| | conditions | | [° C.] | | | | | | | | |
| | | | Retention | 5 | 5 | 5 | 5 | 5 | 5 | 5 | 5 |
| | | | time [h] | | | | | | | | |
| | | Crystal | Temper- | 680 | 570 | 690 | 670 | 670 | 660 | 680 | 700 |
| | | growth | ature | | | | | | | | |
| | | | [° C.] | | | | | | | | |
| | | | Retention | 5 | 5 | 5 | 5 | 5 | 5 | 5 | 5 |
| | | | time [h] | | | | | | | | |

| | | | | |
|---|---|---|---|---|
| Glass transition point (Tg) [° C.] | | | | |
| Softening point (SP) [° C.] | 789 | 763 | 797 | 799 |

[symbol]

indicates data missing or illegible when filed

### 2. Evaluation of Inorganic Composition Article

The following properties of the obtained inorganic composition article were measured. The results are shown in Tables 2 and 3.

### [Stress Measurement]

The compressive stress (CS) of the outermost surface was measured using an FSM-6000LE series glass surface stress meter manufactured by Orihara Manufacturing Co., Ltd., and a light source with a wavelength of 365 nm was used as the light source for the measuring instrument.

The refractive index used for CS measurement was the value of the refractive index at 365 nm. Besides, the refractive index value was calculated by using a quadratic approximation expression from the measured values of the refractive index at the wavelengths of a C-line, a d-line, an F-line, and a g-line according to the V-block method specified in JIS B 7071-2:2018.

The photoelastic constant used for CS measurement was the value of the photoelastic constant at 365 nm. Besides, the value of the photoelastic constant can be calculated from the measured values of the photoelastic constant at a wavelength of 435.8 nm, 546.1 nm, and 643.9 nm by using a quadratic approximation equation. In the examples, a representative value of the photoelastic constant was 31.3.

The photoelastic constant (β) was determined by polishing the sample on the opposite surfaces to form a disk shape with a diameter of 25 mm and a thickness of 0.8 mm, applying a compressive load in a specified direction, measuring the optical path difference generated at the center of the glass, and calculating the constant using the relational equation δ=β·d·F. In this relational equation, the optical path difference is expressed as δ (nm), the glass thickness as d (mm), and the stress as F (MPa).

The depth DOLzero (μm) and the central tensile stress (CT) when the compressive stress of the compressive stress layer is 0 MPa were measured using SLP-1000, an scattered light photoelastic stress meter. A light source having a wavelength of 405 nm and 518 nm was used as the measurement light source.

The refractive index value at a wavelength of 405 nm was calculated by using a quadratic approximation expression from the measured values of the refractive index at the wavelengths of a C-line, a d-line, an F-line, and a g-line according to the V-block method specified in JIS B 7071-2:2018.

A value of a photoelastic constant at a wavelength of 405 nm and 518 nm used for the DOLzero and CT measurements can be calculated from the measured values of the photoelastic constant at a wavelength of 435.8 nm, 546.1 nm, and 643.9 nm by using a quadratic approximation equation. In the examples, 31.0 at a wavelength of 405 nm and 30.1 at a wavelength of 518 nm were used as representative values.

TABLE 2

| | | | Example | Example | Example | Example | Example | Example | Example | Example |
|---|---|---|---|---|---|---|---|---|---|---|
| | | | 1 | 2 | 3 | 4 | 5 | 6 | 7 | 8 |
| Chemical | Substrate thickness | | [symbol] | 0.7 | [symbol] | 0.7 | 0.7 | 0.7 | [symbol] | [symbol] |
| strengthening | First stage | Salt bath | [symbol] 20 [symbol] | Na single | [symbol] 10: | Na single | [symbol] 10 [symbol] | Na single | [symbol] 10 [symbol] | Na single |
| conditions | | conditions | [symbol] 1 | bath | [symbol] 1 | bath | [symbol] 1 | bath | [symbol] 1 | bath |
| | | Salt bath | 450° C. × | 420° C. × | 420° C. × | 420° C. × | 450° C. × | 420° C. × | 420° C. × | 420° C. × |
| | | time | 120 min. | 120 min. | 120 min. | 120 min. | 120 min. | 120 min. | 120 min. | 120 min. |
| | Second | Salt bath | K single | [symbol] 50: | K single | K single | [symbol] 50 | K single | K single | K single |
| | stage | conditions | bath | [symbol] 1 | bath | bath | | bath | bath | bath |
| | | Salt bath | 400° C. × | 400° C. × | 400° C. × | 400° C. × | 400° C. × | 400° C. × | 400° C. × | 400° C. × |
| | | time | 200 min. | 500 min. | 300 min. | 500 min. | 200 min. | 300 min. | [symbol] min. | [symbol] min. |

| | | | | | | | | |
|---|---|---|---|---|---|---|---|---|
| CS (MPa) | 1018 | 827 | 880 | 625 | 711 | 867 | 861 | 932 |
| CT (MPa) | 99 | 105 | 78 | 46 | 149 | 104 | 73 | 83 |
| [symbol] (μm) | 132 | 96 | 90 | 87 | 132 | 130 | 117 | 121 |

[symbol]

indicates data missing or illegible when filed

TABLE 3

| | | | Example | Example | Example | Example | Example | Example | Example | Example | Comparative |
|---|---|---|---|---|---|---|---|---|---|---|---|
| | | | 9 | 10 | 11 | 12 | 13 | 14 | 15 | 16 | Example 1 |
| Chemical | Substrate thickness | | 0.8 | 0.7 | 0.8 | 0.7 | 0.7 | 0.7 | 0.7 | 0.7 | 0.6 |
| strengthening | First stage | Salt bath | [symbol] 10: | Na single | Na single | [symbol] single | [symbol] 10: | [symbol] 10: | [symbol] 10: | [symbol] 10: | Na single |
| conditions | | conditions | [symbol] 1 | bath | bath | bath | [symbol] 1 | [symbol] 1 | [symbol] 1 | [symbol] 1 | bath |
| | | Salt bath | 420° C. × | 420° C. × | 420° C. × | 420° C. × | 450° C. × | 450° C. × | 450° C. × | 450° C. × | 490° C. × |
| | | time | 120 min. | 100 min. | 120 min. | 100 min. | 120 min. | 120 min. | 120 min. | 120 min. | 300 min. |
| | Second | Salt bath | K single | [symbol] 50: | [symbol] 50: | K single | [symbol] 50: | [symbol] 50: | [symbol] 50: | [symbol] 50: | K single |
| | stage | conditions | bath | [symbol] , 1 | [symbol] 1 | bath | [symbol] 1 | [symbol] 1 | [symbol] 1 | [symbol] 1 | bath |
| | | Salt bath | 400° C. × | 400° C. × | 400° C. × | 400° C. × | 400° C. × | 400° C. × | 400° C. × | 400° C. × | 500° C. × |
| | | time | 300 min. | 300 min. | 500 min. | 300 min. | 300 min. | 300 min. | 300 min. | 300 min. | 60 min, |

| | | | | | | | | | |
|---|---|---|---|---|---|---|---|---|---|
| CS (MPa) | 673 | 708 | 881 | 882 | 696 | 666 | 689 | 717 | 1142 |
| CT (MPa) | 95 | 144 | 63 | 64 | 124 | 131 | 121 | 131 | 97 |
| DOLzero (μm) | 135 | 143 | 129 | 135 | 125 | 136 | 122 | 127 | 123 |

[symbol]

indicates data missing or illegible when filed

Although several embodiments and/or examples of the present disclosure have been described in detail above, those skilled in the art will readily be able to make numerous modifications to these illustrative embodiments and/or examples without substantially departing from the novel teachings and effects of the present disclosure. Accordingly, such numerous modifications are intended to be within the scope of the present disclosure.

The contents of all documents cited in the present specification and of the application from which the present application claims priority under the Paris Convention are incorporated by reference in their entirety.

1. An inorganic composition article including at least one type selected from α-cristobalite and an α-cristobalite solid solution as a main crystalline phase,
wherein the inorganic composition article is obtained by reinforcing a crystallized glass where, by mass % in terms of oxide,
a content of a SiO₂ component is 45.0% to less than 68.0%,
a content of an Al₂O₃ component is 3.0% to 15.0%,
a content of a Li₂O component is 3.0% to 10.0%,
a content of a B₂O₃ component is more than 0% to 10.0%,
a content of a P₂O₅ component is more than 0% to 10.0%,
a content of a ZrO₂ component is more than 0% to 10.0%, and
a mass ratio represented by SiO₂/(B₂O₃+Li₂O) is 3.0 to 10.0, and
the inorganic composition article has a surface formed thereon with a compressive stress layer and a softening point (SP) of less than 795° C.

2. The inorganic composition article according to claim 1, wherein, in the crystallized glass, by mass % in terms of oxide,
a total content of the Al₂O₃ component and the ZrO₂ component is 10.0% or more.

3. The inorganic composition article according to claim 1, wherein, in the crystallized glass, by mass % in terms of oxide,
a content of a K₂O component is 0% to 5.0%,
a content of a Na₂O component is 0% to 4.0%,
a content of a MgO component is 0% to 4.0%,
a content of a CaO component is 0% to 4.0%,
a content of a SrO component is 0% to 4.0%,
a content of a BaO component is 0% to 5.0%,
a content of a ZnO component is 0% to 10.0%, and
a content of a Sb₂O₃ component is 0% to 3.0%.

4. The inorganic composition article according to claim 1, wherein, in the crystallized glass, by mass % in terms of oxide,
a content of a Nb₂O₅ component is 0% to 5.0%,
a content of a Ta₂O₅ component is 0% to 6.0%, and
a content of a TiO₂ component is 0% or more and less than 1.0%.

5. The inorganic composition article according to claim 1, wherein a glass transition temperature (Tg) of the crystallized glass after crystallization is 610° C. or lower.

6. The inorganic composition article according to claim 2, wherein, in the crystallized glass, by mass % in terms of oxide,
a content of a K₂O component is 0% to 5.0%,
a content of a Na₂O component is 0% to 4.0%,
a content of a MgO component is 0% to 4.0%,
a content of a CaO component is 0% to 4.0%,
a content of a SrO component is 0% to 4.0%,
a content of a BaO component is 0% to 5.0%,
a content of a ZnO component is 0% to 10.0%, and
a content of a Sb₂O₃ component is 0% to 3.0%.

7. The inorganic composition article according to claim 2, wherein, in the crystallized glass, by mass % in terms of oxide,
a content of a Nb₂O₅ component is 0% to 5.0%,
a content of a Ta₂O₅ component is 0% to 6.0%, and
a content of a TiO₂ component is 0% or more and less than 1.0%.

8. The inorganic composition article according to claim 3, wherein, in the crystallized glass, by mass % in terms of oxide,
a content of a Nb₂O₅ component is 0% to 5.0%,
a content of a Ta₂O₅ component is 0% to 6.0%, and
a content of a TiO₂ component is 0% or more and less than 1.0%.

9. The inorganic composition article according to claim 2, wherein a glass transition temperature (Tg) of the crystallized glass after crystallization is 610° C. or lower.

10. The inorganic composition article according to claim 3, wherein a glass transition temperature (Tg) of the crystallized glass after crystallization is 610° C. or lower.

11. The inorganic composition article according to claim 4, wherein a glass transition temperature (Tg) of the crystallized glass after crystallization is 610° C. or lower.
